(19) United States
(12) Patent Application Publication
(10) Pub. No.: US 2012/0078745 A1
(43) Pub. Date: Mar. 29, 2012

(54) METHODS AND APPARATUS FOR APPLYING BIDS USED IN A PRIMARY AUCTION TO A SECONDARY AUCTION

(76) Inventors: Frank Han, Menlo Park, CA (US); Manfred Hasseler, Hechendorf (DE)

(21) Appl. No.: 12/892,609

(22) Filed: Sep. 28, 2010

(51) Int. Cl. G06Q 30/00

(52) U.S. Cl. 705/26.3

(57) ABSTRACT

In some embodiments, a non-transitory processor readable-medium stores code representing instructions to cause a processor to receive, before a time period, a first signal indicating that a first user has purchased a set of primary bids. Each primary bid from the set of primary bids has a price. The code further represents instructions to cause the processor to receive, within the time period, a set of second signals. Each signal from the set of second signals indicates that the first user has used a primary bid from the set of primary bids to bid on an item in a primary auction. The code represents instructions to cause the processor to award, after the time period, the first user at least one secondary bid based on a second user being awarded the item in the primary auction.

### RELATED APPLICATIONS

This application is related to co-pending U.S. patent application Ser. No. 12/640,664, filed on Dec. 17, 2009, and entitled “Methods and Apparatus for Applying Auction Bids Towards the Purchase of an Item”; co-pending U.S. patent application Ser. No. 11/421,100, filed on May 31, 2006, and entitled “Process for Automatic Determination of an End Value”; and co-pending U.S. patent application Ser. No. 11/768,364, filed on Jun. 26, 2007, and entitled “Method for the Automatic Determination of an End Value,” each of which is incorporated herein by reference in its entirety.

### BACKGROUND

Embodiments described herein relate generally to auctions and more particularly to applying bids used in a primary auction to a secondary auction.

Various forms of auctions are known. Such known auctions allow users to bid on an item for a predetermined amount of time. Once the predetermined amount of time elapses, the bidder who bids the highest amount is awarded the item. In many known auctions the highest bidder is also the final bidder in the auction. The other participants in the auction do not receive anything for casting bids in the auction. This can discourage some users from participating in future auctions. Moreover, if the auction requires a participant to purchase the bids cast in the auction, the cost of the bids is lost to the user and the user does not receive anything for purchasing the bids. Thus, in such known auctions a user who is not awarded the item in the auction does not gain by participating in the auction.

Accordingly, a need exists for methods and apparatus that provide a benefit to a bidder who is not awarded an item in an auction.

### SUMMARY

In some embodiments, a non-transitory processor readable-medium stores code representing instructions to cause a processor to receive, before a time period, a first signal indicating that a first user has purchased a set of primary bids. Each primary bid from the set of primary bids has a price. The code further represents instructions to cause the processor to receive, within the time period, a set of second signals. Each signal from the set of second signals indicates that the first user has used a primary bid from the set of primary bids to bid on an item in a primary auction. The code represents instructions to cause the processor to award, after the time period, the first user at least one secondary bid based on a second user being awarded the item in the primary auction.

### BRIEF DESCRIPTION OF THE DRAWINGS

FIG. 1 is a schematic diagram that illustrates communication devices in communication with a host device via a network, according to an embodiment.

FIG. 2 is a flow chart illustrating a method of managing an auction, according to another embodiment.

FIGS. 3 and 4 are tables illustrating an example of an auction, according to another embodiment.

FIG. 5 is a flow chart illustrating a method of managing a primary auction and a secondary auction, according to another embodiment.

FIG. 6 is a schematic illustration of a processor of a host device, according to another embodiment.

FIG. 7 is a flow chart illustrating a method of managing a primary auction and a secondary auction, according to another embodiment.

### DETAILED DESCRIPTION

In some embodiments, a non-transitory processor readable-medium stores code representing instructions to cause a processor to receive, before a time period, a first signal indicating that a first user has purchased a set of primary bids. Each primary bid from the set of primary bids has a price. The code further represents instructions to cause the processor to receive, within the time period, a set of second signals. Each signal from the set of second signals indicates that the first user has used a primary bid from the set of primary bids to bid on an item in a primary auction. The code represents instructions to cause the processor to award, after the time period, the first user at least one secondary bid based on a second user being awarded the item in the primary auction.

In some embodiments, the secondary bid can be used in a secondary auction for another item and/or to purchase another item at a discounted price. In such embodiments, the user can bid in the secondary auction against other users also with secondary bids. This allows users that do not win a primary auction to still gain from participating in the primary auction (i.e., such users receive secondary bids).

In some embodiments, a non-transitory processor readable-medium stores code representing instructions to cause a processor to receive, within a first time period, a first set of signals indicating that a first user has used a first set of primary bids to bid on a first item at a primary auction. The code represents instructions to cause the processor to receive, within the first time period, a second set of signals indicating that a second user has used a second set of primary bids to bid on the first item at the primary auction. The code further represents instructions to cause the processor to award, after the first time period but before a second time period, the first item to the second user and at least one secondary bid to the first user based on the first item being awarded to the second user. The code represents instructions to cause the processor to receive, within the second time period, at least one signal indicating that the first user has used the at least one secondary bid in a secondary auction for a second item.

In some embodiments, an apparatus includes a primary auction module and a secondary auction module. The primary auction module is to receive a first set of signals indicating that a set of users has used a set of primary bids in a primary auction for a first item. The primary auction module is to award the first item to a first user from the set of users and at least one secondary bid to each remaining user from the set of users based on the first user being the last user to use a primary bid from the set of primary bids in the primary auction. The secondary auction module is to receive a second set of signals indicating that a portion of the remaining users from the set of users has used a set of secondary bids in a secondary auction for a second item. The secondary auction module is to award the second item to a second user from the set of users based on the second user being the last user from the portion of the remaining users from the set of users to use a secondary bid from the set of secondary bids in the secondary auction.

As used in this specification, the singular forms “a,” “an” and “the” include plural referents unless the context clearly dictates otherwise. Thus, for example, the term “a communication device” is intended to mean a single communication device or multiple communication devices; and “network” is intended to mean one or more networks, or a combination thereof.

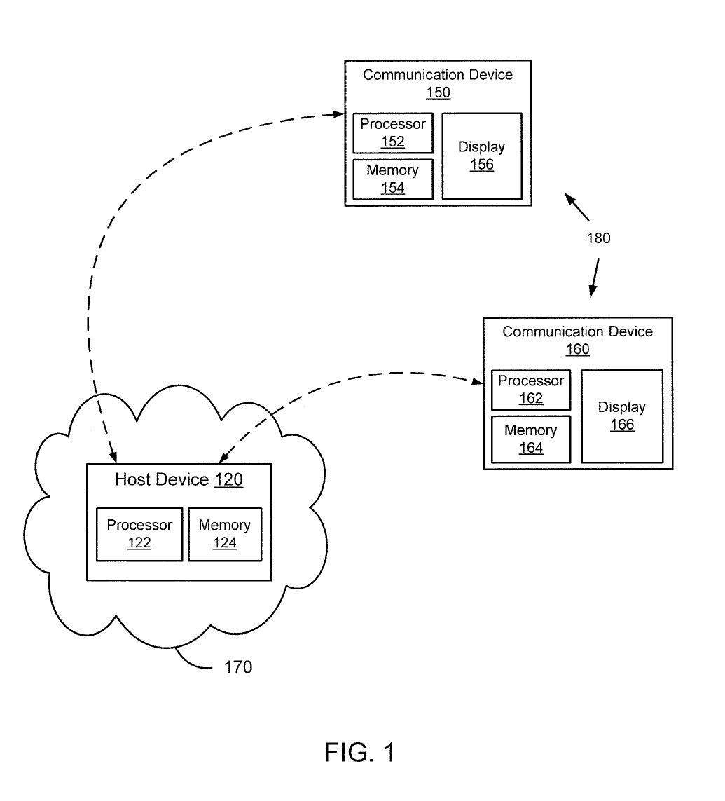

FIG. 1 is a schematic diagram that illustrates communication devices 180 in communication with a host device 120 via a network 170, according to an embodiment. Specifically, communication device 150 is configured to communicate with the host device 120. Similarly, communication device 160 is configured to communicate with the host device 120. The network 170 can be any type of network (e.g., a local area network (LAN), a wide area network (WAN), a virtual network, a telecommunications network) implemented as a wired network and/or wireless network. As described in further detail herein, in some embodiments, for example, the communication devices 180 are personal computers connected to the host device 120 via an internet service provider (ISP) and the Internet (e.g., network 170).

The host device 120 can be any type of device configured to send data over the network 170 to and/or receive data from one or more of the communication devices 180. In some embodiments, the host device 120 can be configured to function as, for example, a server device (e.g., a web server device), a network management device, and/or so forth.

The host device 120 includes a memory 124 and a processor 122. The memory 124 can be, for example, a random access memory (RAM), a memory buffer, a hard drive, a database, and/or so forth. In some embodiments, the memory 124 of the host device 120 includes data used to facilitate an auction. In such embodiments, for example, the host device 120 is configured to manage the auction. As such, the host device 120 can send data to and receive data from the communication devices 180 associated with the auction. For example, as described in further detail herein, the host device 120 can send data associated with a state of the auction (e.g., a price of an item, the time left in the auction, a number of participants in the auction, etc.) to the communication devices 180. Additionally, the host device 120 can send user specific data (e.g., the number of bids a user has used in the auction, a listing of auctions the user is monitoring, a listing of auctions the user might be interested in based on past bidding or a user profile, etc.) associated with a user of the communication device 150 (or communication device 160). In some embodiments, the host device 120 can receive data from the communication devices 180 pertaining to the auction. For example, the host device can receive an indication that a user of a communication device 180 wishes to bid on an item in an auction, a user of a communication device 180 wishes to purchase bids for an auction, a user of a communication device 180 wishes to logon to their account, and/or the like.

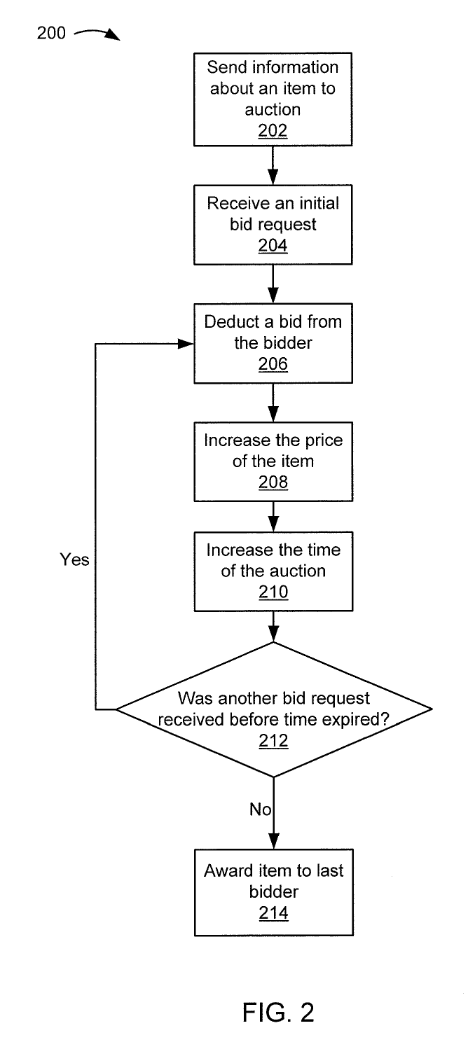

In some embodiments, the host device 120 can manage two types of auctions in which two different types of bids are used. A described in further detail herein, for example, the host device 120 can manage primary auctions, in which primary bids are used, and secondary auctions, in which secondary bids are used. In some embodiments, primary auctions and secondary auctions can operate in a similar manner (e.g., using method 200 of FIG. 2).

As used herein, a primary auction can be an auction in which a user purchases primary bids. Similarly stated, prior to bidding on an item in a primary auction, a user can purchase a number of primary bids. In such embodiments, each primary bid can cost the user an amount. Each primary bid allows a user to bid in a primary auction. Said another way, purchasing a primary bid gives the user the right to bid on an item in a primary auction. Each time a user bids in a primary auction, they use a primary bid. As such, in response to receiving a bid request in a primary auction, a primary bid is deducted from the bidder's account. In other embodiments, a user does not purchase the primary bid in advance and pays for the primary bid when the primary bid is placed in the primary auction. Thus, instead of deducting a primary bid from the bidder, the host device charges the bidder a price each time the bidder places a primary bid in a primary auction.

As used herein, a secondary auction can be an auction in which the user does not purchase bids prior to bidding in the auction. More specifically, in some embodiments, a user can be awarded complimentary and/or free secondary bids by the host device as a result of various actions by the user. As described in further detail herein, for example, the host device can award secondary bids to users who bid in a primary auction but do not win the primary auction (i.e., are not awarded the item in the primary auction). In such embodiments, the number of secondary bids awarded to a user can be proportional to and/or dependent on a number of primary bids that user used in the primary auction. In other embodiments, a user can also be awarded secondary bids for referring friends to a primary and/or secondary auction, advertising a primary and/or secondary auction, submitting a review of a primary and/or secondary auction, posting a message about a primary and/or secondary auction, participating in a number of primary and/or secondary auctions, purchasing a number of primary bids, and/or the like.

Each secondary bid allows a user to bid in a secondary auction. Said another way, being awarded a secondary bid gives the user the right to bid on an item in a secondary auction. Each time a user bids in a secondary auction, they use a secondary bid. As such, in response to receiving a bid request in a secondary auction, a secondary bid is deducted from the bidder's account.

In some embodiments, the memory 124 of the host device 120 acts as a data repository. In such embodiments, the data associated with the auctions (auction price, auction time, data pertaining to an individual user, statistical data, and/or the like) is stored in the memory 124 of the host device 120. When a user wishes to view data associated with a specific auction and/or a user profile, the host device 120 can send the data to the user when a signal requesting the data is received from a communication device.

Further, in some embodiments, the memory 124 of the host device 120 stores account information associated with the users. In such embodiments, for example, the host device 120 can store a username and password associated with a user, preferences associated with the user, a listing of auctions participated in by the user, a listing of the auctions the user has won, a number of the user's unused primary and/or secondary bids, and/or the like. In other embodiments, such information is stored in a database (not shown in FIG. 1) operatively coupled to the host device 120.

Each of the communication devices 180 can be, for example, a computing entity (e.g., a personal computing device such as a desktop computer, a laptop computer, etc.), a mobile phone, a monitoring device, a personal digital assistant (PDA), and/or so forth. Although not shown, in some embodiments, each of the communication devices 180 can include one or more network interface devices (e.g., a network interface card) configured to connect the communication devices 180 to the network 170. In some embodiments, the communication devices 180 can be referred to as client devices.

As shown in FIG. 1, the communication device 160 has a processor 162, a memory 164, and a display 166. The memory 164 can be, for example, a random access memory (RAM), a memory buffer, a hard drive, and/or so forth. The display 166 can be any suitable display, such as, for example, a liquid crystal display (LCD), a cathode ray tube display (CRT) or the like. Similar to communication device 160, the communication device 150 has a processor 152, a memory 154, and a display 156.

In some embodiments, a web browser application can be stored in the memory 164 of the communication device 160. Using the web browser application, the communication device 160 can send data to and receive data from the host device 120. Similarly, the communication device 150 can include a web browser application. In such embodiments, the communication devices 180 act as thin clients. This allows minimal data to be stored on the communication devices 180. In other embodiments, the communication devices 180 can include an application specific to communicating with the host device 120 during auctions. In such embodiments, the communication devices 180 can download the application from the host device 120 prior to participating in an auction.

As discussed above, the communication devices 180 can send data to and receive data from the host device 120 associated with an auction. In some embodiments, the data sent between the communication devices 180 and the host device 120 can be formatted using any suitable format. In some embodiments, for example, the data can be formatted using extensible markup language (XML), hypertext markup language (HTML) and/or the like.

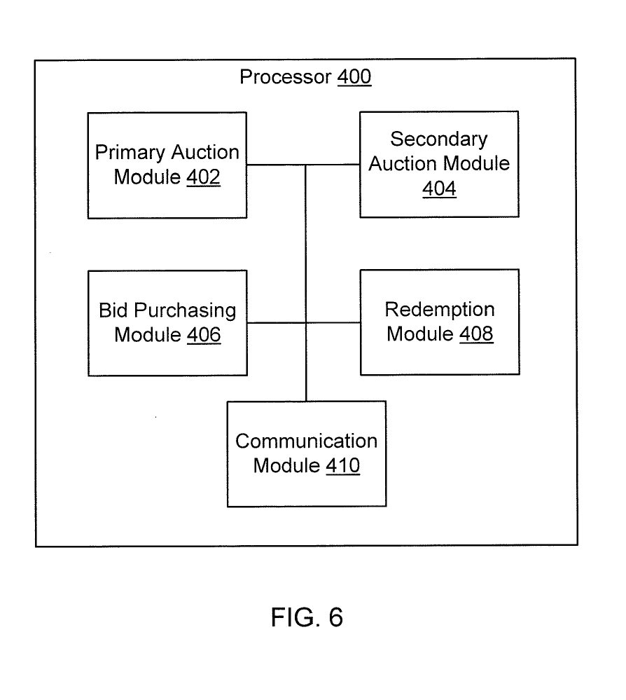

In some embodiments, one or more portions of the host device 120 and/or one or more portions of the communication devices 180 can include a hardware-based module (e.g., a digital signal processor (DSP), a field programmable gate array (FPGA)) and/or a software-based module (e.g., a module of computer code to be executed at a processor, a set of processor-readable instructions that can be executed at a processor). In some embodiments, one or more of the functions associated with the host device 120 (e.g., the functions associated with the processor 122) can be included in one or more modules (see, e.g., FIG. 6). In some embodiments, one or more of the functions associated with the communication devices 180 (e.g., functions associated with processor 152 or processor 162) can be included in one or more modules. In some embodiments, one or more of the communication devices 180 can be configured to perforin one or more functions associated with the host device 120, and vice versa.

FIG. 2 is a flow chart illustrating a method 200 of managing an auction (i.e., either a primary auction using primary bids or a secondary auction using secondary bids), according to another embodiment. Initially, information associated with an auction is sent to one or more communication devices, at 202. For example, a host device (e.g., host device 120) can send information about an item to be auctioned (i.e., in a primary auction or a secondary auction) to the communication devices (e.g., communication devices 180). In some embodiments, the information can be sent to a communication device in response to a request for the information made by the communication device. For example, the host device can publish the information to a website accessible by the communication device. When the communication device requests access to the website, the host device can send the information associated with the auction to the communication device. In such embodiments, a user of the communication device can view the information associated with the auction over the Internet. In other embodiments, the communication device can view the information associated with the auction over any other suitable network, such as, for example, an intranet, a local area network (LAN) or the like.

In some embodiments, the information associated with the auction can include, for example, details about an item to be auctioned (e.g., a description of the item, a photograph of the item, a retail price of the item, etc.), a current price of the item in the auction, a number of bids received in the auction, a minimum price for the item, an identifier of the user who last bid in the auction, a time remaining in the auction, a number of secondary bids to be awarded a user if they do not win a primary auction, and/or the like.

An initial bid request is received, at 204. The host device can receive the initial bid request from, for example, a communication device. More particularly, a user of a communication device can cause the communication device to send a signal to the host device indicating the user's intent to bid in the auction.

As discussed above, each time a user bids in an auction, they use a bid. More specifically, each time a user bids in a primary auction they use a primary bid and each time a user bids in a secondary auction they use a secondary bid. As such, in response to receiving the initial bid request, at 204, a bid (i.e., either a primary bid or a secondary bid depending on the type of auction) is deducted from the bidder's account (i.e., the user making the initial bid), at 206.

Additionally, in response to receiving the initial bid request, at 204, the price of the item in the auction is increased, at 208. In some embodiments, the price of the item is increased by a predetermined amount. In such embodiments, for example, each time a bid is received from a user, the price of the item is increased by the same amount. In some embodiments, for example, each time a bid request is received from a communication device, the host device increases the price of the item in the auction by $0.50. In other embodiments, the price of the item in the auction can be increased by any amount in response to receiving a bid. In still other embodiments, the user bidding on the item can choose how much to increase the price of the item in the auction. In some embodiments, the price of an item in a primary auction can be increased by a first amount (e.g., $0.01) in response to receiving a primary bid and the price of an item in a secondary auction can be increased by a second amount (e.g., $0.10) in response to receiving a secondary bid. In other embodiments, a price of an item in a primary auction and a price of an item in a secondary auction can be increased by a same amount in response to receiving a primary bid and a secondary bid, respectively.

In response to receiving the initial bid request, at 204, the time of the auction is also increased, at 210. Said another way, the duration of the auction can be increased in response to receiving an indication that a user has used a bid in the auction. In some embodiments, whenever a bid request is received, the duration of the auction is reset to an amount of time. For example, each time a bid request is received, the duration of the auction can be reset to 15 seconds. Thus, if a bid request is received with 7 seconds remaining in the auction, the duration of the auction can be reset to 15 seconds. Similarly, if a bid request is received with 1 second remaining in the auction, the duration of the auction can be reset to 15 seconds. In such embodiments, if the time remaining in the auction is greater than the amount to be reset to (e.g., 15 seconds in the current example), the amount of time remaining in the auction is not changed. Thus, in the current example, if the amount of time remaining in the auction is 30 seconds when a bid is received, the amount of time remaining in the auction remains at 30 seconds because the amount of time is greater than 15 seconds. In other embodiments, each time a bid request is received, the duration of the auction can be reset to any suitable amount of time.

In still other embodiments, a predetermined amount of time can be added to the auction when a bid request is received. For example, each time a bid request is received, 10 seconds can be added to the duration of the auction. Thus, if a bid request is received with 7 seconds remaining in the auction, the duration of the auction can be reset to 17 seconds. Similarly, if a bid request is received with 1 second remaining in the auction, the duration of the auction can be reset to 11 seconds. In other embodiments, each time a bid request is received, any suitable amount of time can be added to the duration of the auction.

In yet other embodiments, each time a bid request is received, the duration of the auction can be reset to a random amount of time. In still other embodiments, each time a bid request is received, the duration of the auction can be reset to and/or increased by an amount of time based on a number of bids received in the auction, a number of bids recently received in the auction (e.g., within the last 30 seconds), a price of the auction, a total duration of the auction (e.g., a difference between the current time and the time the auction began), a number of bidders actively participating in the auction, and/or any other suitable metric.

In some embodiments, a duration of a primary auction can be reset to and/or increased by a first amount in response to receiving a primary bid and a duration of a secondary auction can be increased by a second amount in response to receiving a secondary bid. In other embodiments, a duration of a primary auction and a duration of a secondary auction can be reset to and/or increased by a same amount of time in response to receiving a primary bid and a secondary bid, respectively.

The host device continues to monitor the auction to determine whether another bid request is received before the time of the auction expires, at 212. If another bid is received, the host device returns to step 206 to deduct a bid from the subsequent bidder, at 206, increase the price of the item, at 208, and increase the time of the auction, at 210. Thus, the auction continues until the bidders stop bidding in the auction before the time of the auction expires.

If the host device does not receive a subsequent bid request before the time of the auction expires, the item in the auction is awarded to the last bidder, at 214, for the current auction price of the item. Accordingly, the winner of the auction pays the current price of the item in the auction. As described in further detail herein, in some embodiments, the losers of the auction (i.e., those users who bid in the auction but did not win the auction) can be awarded a number of secondary bids. In some embodiments, such secondary bids can be free and/or complementary. If the auction was a primary auction, the number of secondary bids awarded to a user can be proportional to and/or based on a number of primary bids the user used in the primary auction. Similarly, if the auction was a secondary auction, the number of secondary bids awarded can be proportional to and/or based on a number of secondary bids the user used in the secondary auction. In some embodiments, a number of secondary bids used in a secondary auction can be returned and/or recredited to a losing user of the secondary auction.

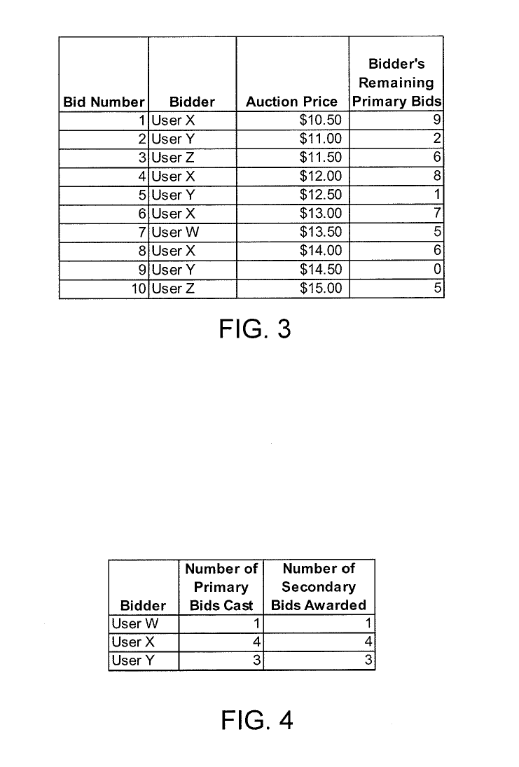

FIG. 3 illustrates the history of a primary auction in which four users (User W, User X, User Y, and User Z) participated. In the current example, prior to the primary auction, each of the users purchases a number of primary bids for $1.00 each. For example, User W purchases 6 primary bids at $1.00 each for a total of $6.00, User X purchases 10 primary bids at $1.00 each for a total of $10.00, User Y purchases 3 primary bids at $1.00 each for a total of $3.00, and User Z purchases 7 primary bids at $1.00 each for a total of $7.00. Accordingly, User W can place a total of 6 primary bids in the primary auction, User X can place a total of 10 primary bids in the primary auction, User Y can place a total of 3 primary bids in the primary auction and user Z can place a total of 7 primary bids in the primary auction. In some embodiments, these primary bids can be used not only in the current primary auction but can be retained and used in future primary auctions and/or simultaneously occurring primary auctions. In other embodiments, each primary bid can be only used in the current primary auction.

In the current example, the initial starting price for the item in the primary auction is $10.00. Each time a primary bid is used, the price of the item is increased by $0.50 and a primary bid is deducted from the user who placed the primary bid. The $10.00 initial starting price ensures that the auctioneer will receive no less than $10.00 for the item. In other embodiments, the initial starting price can be any value, including $0.00.

As shown in FIG. 3, User X places the first primary bid in the primary auction. In response to placing the primary bid, the auction price is increased by $0.50 to $10.50. Additionally, the number of primary bids that User X has is decreased from 10 to 9. The second primary bid is placed by User Y. Similar to the first primary bid, in response to the second primary bid the auction price is increased by $0.50 to $11.00 and the number of primary bids that User Y has is decreased from 3 to 2. The auction continues in such a manner until User Z places the tenth primary bid of the auction. This increases the price by $0.50 to $15.00 and decreases User Z's remaining primary bids to 5. After User Z's primary bid, no other primary bids are received before the time of the auction expires. Accordingly, because User Z was the last user to use a primary bid in the auction when the time of the auction expired, the item is awarded to User Z for a price of $15.00.

In some embodiments, User W, User X and User Y (i.e., those users who did not win the primary auction) are awarded a number of secondary bids equal to, proportional to, and/or otherwise based on the number of primary bids each user used in the primary auction. For example, as shown in FIG. 4, each losing user (i.e., User W, User X and User Y) is awarded one secondary bid for each primary bid used in the primary auction. Accordingly, User W, who used one primary bid in the primary auction, is awarded one secondary bid; User X, who used four primary bids in the primary auction, is awarded four secondary bids; and User Y, who used three primary bids in the primary auction, is awarded three secondary bids. In some embodiments, such secondary bids are free and/or complementary to the users. As discussed above, the secondary bids awarded to User W, User X and User Y can be used by the users in one or more secondary auctions. Such a secondary auction can function similar to the primary auction.

In other embodiments, any other ratio and/or proportion of primary bids used to secondary bids awarded can be used. In some embodiments, for example, one secondary bid can be awarded for every five primary bids a user who lost a primary auction used in the primary auction. For another example, two secondary bids can be awarded for every primary bid a user who lost a primary auction used in the primary auction.

In still other embodiments, the ratio and/or proportion of primary bids used to secondary bids awarded can be exponential. In such embodiments, for example, one secondary bid can be awarded for the first ten primary bids a user who lost a primary auction used in the primary auction, but two secondary bids can be awarded for every primary bid over ten primary bids the user used in the primary auction. For another example, one secondary bid can be awarded for the first primary bid a user who lost a primary auction used in the primary auction but two secondary bids can be awarded for the second primary bid the user used in the primary auction (i.e., for a total of three secondary bids). In such embodiments, the user can be rewarded for using more primary bids in a primary auction. Accordingly, the user is encouraged to use additional primary bids in the primary auction.

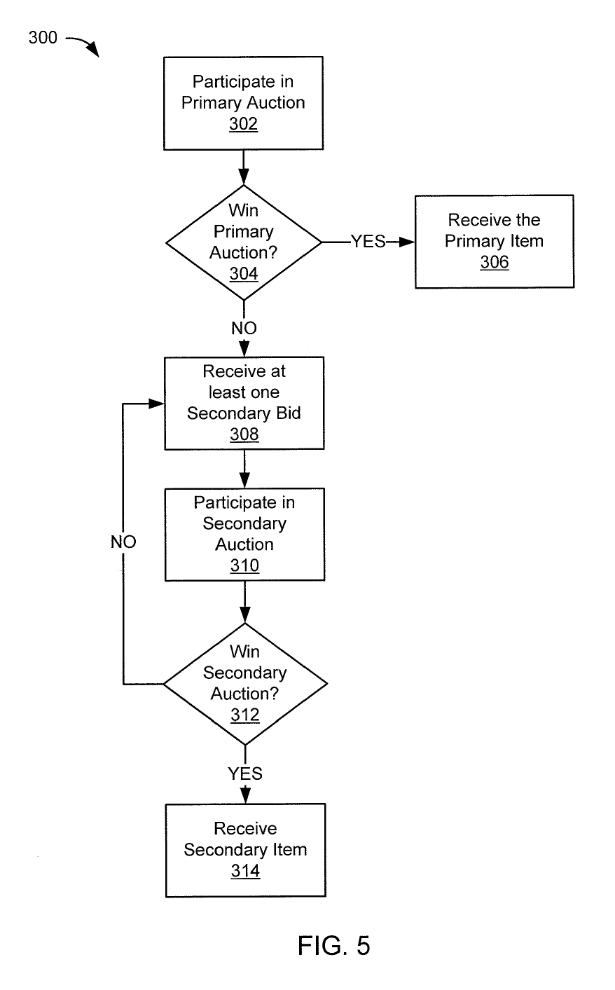

FIG. 5 is a flow chart illustrating a method 300 of managing a primary auction and a secondary auction, according to another embodiment. In some embodiments, such a method 300 can be executed and/or run on a host device (e.g., host device 120 of FIG. 1) and/or one or more communication devices (e.g., communication devices 180 of FIG. 1).

Initially, a user participates in a primary auction for a primary item, at 302. Such a primary auction can operate, function and/or be managed similar to the auction described with respect to FIG. 2. As such, in some embodiments, the user purchases primary bids for a price and uses those primary bids to bid in the primary auction. As described above, each primary bid used can increase the price of the primary item and a value of a timer in the primary auction.

The host device (and/or communication devices) monitors the primary auction and determines whether the user is the winner of the primary auction, at 304. In some embodiments, the user is considered the winner of the primary auction if the user is the last user to use a primary bid in the primary auction and the time of the primary auction has expired. If the user is the winner of the primary auction, the user is awarded the primary item for the end price of the item in the auction, at 306. Accordingly, the winner of the primary auction pays the end price of the primary item in the primary auction.

If the user is not the winner of the primary auction, the user can be awarded at least one secondary bid, at 308. In some embodiments, the at least one secondary bid is free and/or complementary to the user. In some embodiments, the at least one secondary bid can be added to a secondary bid account of the user. Accordingly, the user can accumulate secondary bids from each primary auction in which the user participates but does not win. Using the secondary bids, the user can participate in a secondary auction for a secondary item, at 310. As discussed above the secondary auction can operate, function and/or be managed similar to the auction described with respect to FIG. 2. As such, the secondary auction can operate, function and/or be managed similar to the primary auction.

In some embodiments, the user can be awarded the at least one secondary bid substantially immediately (e.g., in real-time) after the close of the primary auction. In other embodiments, the user is awarded the at least one secondary bid an amount of time after the close of the primary auction. For example, the user can be awarded the at least one secondary bid 30 seconds, one hour, or one day after the close of the primary auction.

The host device (and/or communication devices) monitors the secondary auction and determines whether the user is the winner of the secondary auction, at 312. In some embodiments, the user is considered the winner of the secondary auction if the user is the last user to use a secondary bid in the secondary auction and the time of the secondary auction has expired. If the user is the winner of the secondary auction, the user is awarded the secondary item for the end price of the item in the auction, at 314. Accordingly, the winner of the secondary auction pays the current price of the secondary item in the secondary auction.

In some embodiments, if the user is not the winner of the secondary auction, the user is awarded at least one secondary bid, at 308. Accordingly, as discussed above, in some embodiments some or all of a user's secondary bids are returned and/or recredited to a user if the user does not win the secondary auction. In some embodiments, the at least one secondary bid is free and/or complementary to the user. The user can then use the returned and/or recredited secondary bids to participate in another secondary auction, at 310. Thus, the user can continually use their secondary bids in a secondary auction until they win a secondary auction.

In other embodiments, a different number of secondary bids can be awarded to the user after the secondary auction than the number of secondary bids the user used in the secondary auction. In such embodiments, for example, a user can be awarded a fewer number of secondary bids than the number of secondary bids the user used in the secondary auction. For example, if a user used two bids in a secondary auction that the user did not win, the user can be awarded one secondary bid. In still other embodiments, any other ratio and/or proportion of secondary bids used to secondary bids awarded can used to determine a number of secondary bids to award to a losing user in a secondary auction.

FIG. 6 is a schematic illustration of a processor 400 of a host device (e.g., host device 120 of FIG. 1), according to another embodiment. The processor 400 includes a primary auction module 402, a secondary auction module 404, a bid purchasing module 406, a redemption module 408 and a communication module 410. Such modules can be hardware-based modules (e.g., a digital signal processor (DSP), a field programmable gate array (FPGA)) and/or software-based modules (e.g., a module of computer code to be executed at processor 400, a set of processor-readable instructions that can be executed at a processor 400). While each module is shown in FIG. 6 as being in direct communication with every other module, in other embodiments, each module need not be in direct communication with every other module. For example, the bid purchasing module might not be in direct communication with the secondary auction module.

The communication module 410 can facilitate communication between the processor 400 of the host device and one or more communication devices (e.g., communication devices 180 of FIG. 1). Accordingly, the other modules of the processor 400 can use the communication module 410 to send data to and receive data from the communication devices.

The primary auction module 402 can facilitate, run, manage and/or operate a primary auction. For example, the primary auction module 402 can receive signals from and/or send signals to communication devices participating in a primary auction. Additionally, the primary auction module 402 can determine when a user is using a primary bid in a primary auction, deduct a primary bid from the user's account when the user uses a primary bid in a primary auction, maintain a timer associated with one or more primary auctions, maintain a price of an item in one or more primary auctions, award an item from a primary auction to a winner of that primary auction, award secondary bids to losers of a primary auction, and/or the like.

Similar to the primary auction module 402, the secondary auction module 404 can facilitate, run, manage and/or operate a secondary auction. For example, the secondary auction module 404 can receive signals from and/or send signals to communication devices participating in a secondary auction. Additionally, the secondary auction module 404 can determine when a user is using a secondary bid in a secondary auction, deduct a secondary bid from the user's account when the user uses a secondary bid in a secondary auction, maintain a timer associated with one or more secondary auctions, maintain a price of an item in one or more secondary auctions, award an item from a secondary auction to a winner of that secondary auction, award (e.g., return and/or recredit) secondary bids to losers of a secondary auction, and/or the like.

The bid purchasing module 406 can allow a user to purchase primary bids for use in a primary auction. For example, the bid purchasing module 406 can receive a request from a communication device to purchase one or more primary bids. The bid purchasing module 406 can award and/or credit an account of a user of the communication device with the primary bids in response to the request. After the user's account has been credited with the purchased primary bids, the user can use primary bids in one or more primary auctions.

The redemption module 408 can allow a user to redeem their secondary bids in ways other than using secondary bids in a secondary auction. For example, the redemption module 408 can receive a request from a communication device indicating that a user would like to use one or more secondary bids to purchase an item at a discount price. Similarly stated, the redemption module 408 allows a user to use their secondary bids to obtain a discount on various items. In other embodiments, a user can use secondary bids to purchase services, participate in other online activities, purchase subscriptions, purchase premium bids at a discount, participate in games, participate in contests (e.g., a raffle), and/or the like.

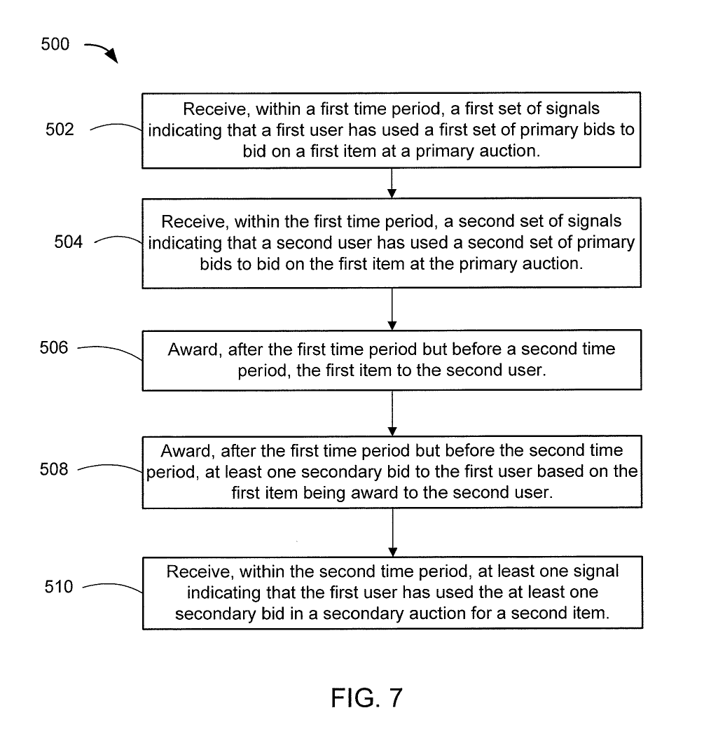

FIG. 7 is a flow chart illustrating a method 500 of managing a primary auction and a secondary auction, according to another embodiment. The method 500 includes receiving, within a first time period, a first set of signals indicating that a first user has used a first set of primary bids to bid on a first item at a primary auction, at 502. A second set of signals indicating that a second user has used a second set of primary bids to bid on the first item at the primary auction are received within the first time period, at 504. Such a primary auction can function and/or operate similar to the auction described with respect to FIG. 2.

The first item is awarded to the second user after the first time period but before a second time period, at 506. In some embodiments, the second user was the last user to use a primary bid in the primary auction when the time of the primary auction expired. Accordingly, the second user purchases the first item for the end price of the first item in the primary auction.

At least one secondary bid is awarded to the first user based on the first item being awarded to the second user after the first time period but before the second time period, at 508. As discussed above, a number of secondary bids awarded to the first user can be proportional to and/or based on a number of bids in the first set of primary bids, which the user used in the primary auction.

At least one signal indicating that the first user has used the at least one secondary bid in a secondary auction for a second item is received within the second time period, at 510. Similar to the primary auction, the secondary auction can function and/or operate similar to the auction described with respect to FIG. 2.

For example, while various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

While shown and described above as only awarding secondary bids to losers of a primary auction, in some embodiments, a winner of a primary auction can also be awarded secondary bids. In such embodiments, each user who uses a bid in a primary auction can be awarded secondary bids based on the number of primary bids that user used in the primary auction. In some embodiments, the winner of the primary auction can receive a fewer number of secondary bids per primary bid submitted in the primary auction.

In some embodiments, primary bids and/or secondary bids can have an expiration date. In such embodiments, for example, each primary bid purchased by a user can expire one year from purchase. Accordingly, a user can use a primary bid in a primary auction within one year of purchasing the primary bid. For another example, each secondary bid awarded to a user can expire one week from the time that secondary bid is awarded to the user. In such an example, a user has one week to use the secondary bid. In other embodiments, primary bids and/or secondary bids can have any suitable expiration date.

In some embodiments, free primary bids can be offered to a user. Such free primary bids can be offered as a result of a promotion, a rewards program (e.g., if you purchase a given number of primary bids you get an additional primary bid free), and/or the like. Similar to purchased primary bids, the free primary bids can be used by the user to bid on items in a primary auction. In other embodiments, secondary bids can be offered as a result of a promotion, a rewards program (e.g., if you purchase a given number of primary bids you get a secondary bid), and/or the like.

In some embodiments, free bids used in a primary auction do not count toward a number of secondary bids a loser of the primary auction receives. For example, if a bidder in a primary auction uses two purchased primary bids and two free primary bids, the bidder can receive secondary bids based on the two purchased primary bids but not the two free primary bids. In other embodiments, free bids do count toward the number of secondary bids a loser of the primary auction receives. In such embodiments, for example, the bidder in the primary auction can receive secondary bids based on both the two purchased primary bids and the two free primary bids.

In some embodiments, a user can purchase primary bids in a primary bid-pack. In such embodiments, the per-bid price of each primary bid can be less if purchased in a primary bid-pack than if purchased as a single primary bid. For example, a bid pack of ten primary bids can cost $5.00 ($0.50 per bid) while a single bid costs $0.60. Accordingly, users can be encouraged to purchase bids in large quantities.

In some embodiments, a user can purchase secondary bids to use in a secondary auction and/or to use as discounts on other items. In such embodiments, secondary bids can cost less than primary bids. For example, a primary bid can cost $0.50 while a secondary bid can cost $0.10. In other embodiments, a secondary bid can cost the same as a primary bid. In still other embodiments, a secondary bid can cost more than a primary bid. In yet other embodiments, as described above, a secondary bid cannot be purchased and is awarded to a user as a result of losing a primary auction and/or a secondary auction.

While shown and described above as being free and/or complementary, in other embodiments, each user that does not win a primary auction pays a price to receive secondary bids. For example, a user that does not win a primary auction can be provided an option to purchase a number of secondary bids for a price. In some embodiments, such a price can be less than the cost of a similar amount of primary bids.

In some embodiments, a first type of item can be auctioned in a primary auction and a second type of item can be auctioned in a secondary auction. In such embodiments, for example, a premium item can be auctioned in a primary auction and a secondary item can be auctioned in a secondary auction. For example, various products (e.g., electronics, handbags, etc.) can be auctioned in the primary auction while gift cards and/or coupons can be auctioned in the secondary auction. In other embodiments, substantially similar types of items are auctioned in both the primary auction and the secondary auction.

While shown and described above as awarding each loser of a primary auction at least one secondary bid, in other embodiments, a user who has previously won a primary auction but loses a subsequent primary auction is not awarded a secondary bid. Accordingly, in such embodiments, secondary bids are awarded to users who have not won a primary auction. In other embodiments, a time associated with how long it has been since a user last won a primary auction is maintained. If the time is greater than a predetermined threshold, the user can be awarded secondary bids while if the time is less than or equal to the predetermined threshold, the user is not awarded secondary bids. In some embodiments, for example, if a user has won a primary bid within the last year, they are precluded from being awarded secondary bids even if they lose a primary auction.

In still other embodiments, a user can be precluded from being awarded secondary bids if the user has won a certain number of primary auctions within a predetermined time period. In some embodiments, for example, if the user has won five or more primary auctions within the last year, the user is precluded from being awarded secondary bids even if they lose a primary auction.

While shown and described above as being able to use secondary bids awarded to losers of a primary auction in multiple secondary auctions, in other embodiments, a user can use secondary bids awarded from a particular primary auction in a single secondary auction. In such embodiments, each user that did not win the primary auction participates in a common secondary auction for a common secondary item. In such embodiments, the secondary bids awarded to each user who did not win the primary auction can be used in the common secondary auction and not in other secondary auctions. In some embodiments, the common secondary auction can be for a similar item as the primary auction. For example, if the primary auction was for a first instance of a electronic device, the secondary auction can be for a second instance of that electronic device. In other embodiments, the item auctioned in the secondary auction is within a same category as the item auctioned in the primary auction (e.g., both items are video games, both items are digital video discs (DVDs), both items are handbags, etc.). In still other embodiments, the item auctioned in the common secondary auction bears no relation to the item auctioned in the primary auction.

In still other embodiments, secondary bids awarded to losers of a first primary auction can be used in a first set of secondary auctions while secondary bids awarded to losers of a second primary auction can be used in a second set of secondary auctions different from the first set of secondary auctions. In some embodiments, an item in a set of secondary auctions that a user can bid on is similar (e.g., within a same category) as the item in the primary auction on which the set of secondary auctions is based. In yet other embodiments, a user can use their secondary bids to bid in any secondary auction.

In some embodiments, a price of an item in a primary auction and/or a timer in a primary auction can be incremented using different intervals than a price of an item in a secondary auction and/or a timer in a secondary auction. In such embodiments, for example, a price of an item in a primary auction can be incremented by $0.01 each time a primary bid is used in the primary auction while a price of an item in a secondary auction can be incremented by $0.10 each time a secondary bid is used in the secondary auction. Similarly, in some embodiments, for example, a timer in a primary auction can be incremented by and/or reset to 15 seconds each time a primary bid is used in the primary auction while a timer in a secondary auction can be incremented by and/or reset to 30 seconds each time a secondary bid is used in the secondary auction.

In some embodiments, a primary auction can include a bid-cap. In such embodiments, a bidder in an auction pays for a specified number of purchased bids (i.e., it costs the user to submit the specified number of bids in the auction). After the bidder has submitted the specified number of purchased bids in the auction (e.g., a bid threshold is reached), the bidder can then bid for free in the auction (i.e., with non-purchased or free bids). Similarly stated, after a bidder has submitted a number of purchased bids in an auction greater than a bid threshold (i.e., the bid-cap is reached), the bidder can bid for free in the auction. For example, a bid cap can be set in an auction to be ten bids. After a bidder submits ten purchased bids in that auction, that bidder can continue to submit free bids (e.g., that have the same effect as purchased bids) in the auction. Both the purchased bids and the free bids can increase the price of the item in the auction and/or the auction timer, as described above. In some embodiments, the number of free bids the bidder can use in the auction is unlimited. In other embodiments, the number of free bids a bidder can use in the auction is based on a number of secondary bids the bidder has, a number of loyalty points a user has accumulated by participating in auctions, a number of auctions a user has participated in and not won, and/or the like. Such a bid-cap can act as an entrance fee into a primary and/or secondary action. As such, a bidder can participate in an auction to the end of the auction while limited their financial exposure in the auction.

In some embodiments, a secondary auction can also include a bid-cap. In such embodiments, after a bidder in a secondary auction submits a specified number of secondary bids in the secondary auction, the bidder can submit bids in the secondary auction without using secondary bids. Similarly stated, after a bidder reaches the bid-cap, any bid the bidder submits in the secondary auction does not deduct a number of secondary bids of the user. Accordingly, after the bid-cap is reached, the bidder can continue to bid in the secondary auction without using their accumulated secondary bids.

While auctions described above are described as auctioning items, in other embodiments, services and/or a combination of items and services can be auctioned. In some embodiments, for example, an auction can be for a house cleaning service, an automobile service, a cab ride, and/or any other service.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

What is claimed is:

1. A non-transitory processor-readable medium storing code representing instructions to cause a processor to:
receive, within a first time period, a first plurality of signals indicating that a first user has used a first plurality of primary bids to bid on a first item at a primary auction;
receive, within the first time period, a second plurality of signals indicating that a second user has used a second plurality of primary bids to bid on the first item at the primary auction;
award, after the first time period but before a second time period, the first item to the second user;
award, after the first time period but before the second time period, at least one secondary bid to the first user based on the first item being awarded to the second user; and
receive, within the second time period, at least one signal indicating that the first user has used the at least one secondary bid in a secondary auction for a second item.

2. The non-transitory processor-readable medium of claim 1, further comprising code representing instructions to cause the processor to:
receive a signal indicating that the first user has purchased the first plurality of primary bids for an amount, the at least one secondary bid being complimentary.

3. The non-transitory processor-readable medium of claim 1, wherein the first item is a first type of item, the second item being a second type of item different than the first type of item.

4. The non-transitory processor-readable medium of claim 1, wherein the secondary auction is a first secondary auction, the non-transitory processor-readable medium further comprising code representing instructions to cause the processor to:
award, after the second time period but before a third time period, the second item to a third user;
recredit, after the second time period but before the third time period, the at least one secondary bid to the first user based on the second item being awarded to the third user; and
receive, within the third time period, at least one signal indicating that the first user has used the at least one secondary bid in a second secondary auction for a third item.

5. The non-transitory processor-readable medium of claim 1, wherein the primary auction is a primary auction from a plurality of primary auctions, the code representing instructions to cause the processor to award at least one secondary bid to the first user includes code representing instructions to cause the processor to award the at least one secondary bid to the first user based on the first item being awarded to the second user and the first user not winning at least one primary auction from the plurality of primary auctions.

6. The non-transitory processor-readable medium of claim 1, wherein the at least one secondary bid is an at least one first secondary bid, the non-transitory processor-readable medium further comprising code representing instructions to cause the processor to:
receive, within the first time period, a third plurality of signals indicating that a third user has used a third plurality of primary bids to bid on the first item at the primary auction;
award, after the first time period but before the second time period, at least one second secondary bid to the third user based on the first item being awarded to the second user; and
receive, within the second time period, at least one signal indicating that the third user has used the at least one second secondary bid as a discount in purchasing a third item.

7. The non-transitory processor-readable medium of claim 1, wherein the second user is not awarded a secondary bid.

8. The non-transitory processor-readable medium of claim 1, wherein the at least one secondary bid is an at least one first secondary bid, the non-transitory processor-readable medium further comprising code representing instructions to cause the processor to:
award, before the second time period, at least one second secondary bid to a third user based on the third user referring a fourth user; and
receive, within the second time period, at least one signal indicating that the third user has used the at least one second secondary bid in the secondary auction for the second item.

9. An apparatus, comprising:
a primary auction module to receive a first plurality of signals indicating that a plurality of users has used a plurality of primary bids in a primary auction for a first item, the primary auction module to award the first item to a first user from the plurality of users and at least one secondary bid to each remaining user from the plurality of users based on the first user being the last user to use a primary bid from the plurality of primary bids in the primary auction; and
a secondary auction module to receive a second plurality of signals indicating that a portion of the remaining users from the plurality of users has used a plurality of secondary bids in a secondary auction for a second item, the secondary auction module to award the second item to a second user from the plurality of users based on the second user being the last user from the portion of the remaining users from the plurality of users to use a secondary bid from the plurality of secondary bids in the secondary auction.

10. The apparatus of claim 9, further comprising:
a bid purchasing module to receive a third plurality of signals indicating that the plurality of users have purchased the plurality of primary bids, each bid from the plurality of primary bids costing an amount, each bid from the plurality of secondary bids being complementary.

11. The apparatus of claim 9, wherein the primary auction module is to award the second user from the plurality of users a first number of secondary bids based on the second user using a first number of primary bids from the plurality of primary bids in the primary auction,
the primary auction module to award a third user from the plurality of users a second number of secondary bids based on the third user using a second number of primary bids from the plurality of primary bids in the primary auction,
the first number of secondary bids being greater than the second number of secondary bids and the first number of primary bids being greater than the second number of primary bids.

12. The apparatus of claim 9, wherein the first user from the plurality of users is not awarded a secondary bid.

13. The apparatus of claim 9, wherein primary bids can only be used in the primary auction.

14. The apparatus of claim 9, further comprising:
a redemption module to receive a signal from a third user from the plurality of users indicating that the third user has used at least one secondary bid to purchase a third item at a discount.

15. The apparatus of claim 9, wherein the first item is a first type of item, the second item being a second type of item different than the first type of item.

16. A non-transitory processor-readable medium storing code representing instructions to cause a processor to:
receive, before a time period, a first signal indicating that a first user has purchased a plurality of primary bids, each primary bid from the plurality of primary bids having a price;
receive, within the time period, a plurality of second signals, each signal from the plurality of second signals indicating that the first user has used a primary bid from the plurality of primary bids to bid on an item in a primary auction; and
award, after the time period, the first user at least one secondary bid based on a second user being awarded the item in the primary auction.

17. The non-transitory processor-readable medium of claim 16, wherein the time period is a first time period, the item is a first item, the non-transitory processor-readable medium further comprising code representing instructions to cause the processor to:
receive, within a second time period after the first time period, a third signal indicating that the first user has used the at least one secondary bid in a secondary auction for a second item.

18. The non-transitory processor-readable medium of claim 16, wherein the time period is a first time period, the item is a first item, the non-transitory processor-readable medium further comprising code representing instructions to cause the processor to:
receive, within a second time period after the first time period, a third signal indicating that the first user has used the at least one secondary bid to purchase a second item at a discount.

19. The non-transitory processor-readable medium of claim 16, wherein the at least one secondary bid can be used in a plurality of secondary auctions until the first user wins a secondary auction from the plurality of secondary auctions using the at least one secondary bid.

20. The non-transitory processor-readable medium of claim 16, wherein the code representing instructions to cause the processor to award the first user the at least one secondary bid includes code representing instructions to cause the processor to award the first user a number of secondary bids based on a number of primary bids from the plurality of primary bids used by the first user to bid on the item in the primary auction.
